(19) United States
(12) Patent Application Publication
(10) Pub. No.: US 2026/0117837 A1
(43) Pub. Date: Apr. 30, 2026

(54) GAS SPRING

(71) Applicant: Mark Manuel, Cape Coral, FL (US)

(72) Inventor: Mark Manuel, Cape Coral, FL (US)

(21) Appl. No.: 18/925,735

(22) Filed: Oct. 24, 2024

(51) Int. Cl. F16F 9/34; F16F 9/02; F16F 9/36

(52) U.S. Cl. CPC F16F 9/3405; F16F 9/0218; F16F 9/369; F16F 2238/026

(57) ABSTRACT

A gas spring is an assembly that includes a pressure tube operatively connected to a spring network. The spring network comprises a first spring set and a second spring set. In the pressure tube, a sealing package is operatively connected to a piston rod. In the pressure tube, a piston package comprises a valve, a first and second stop, and a piston. In the pressure tube, a first guiding package and a second guiding package are in contact with the piston rod. The first guiding package is operatively connected to the sealing package. The second guiding package is operatively connected to the piston package. In the pressure tube, there is a first channel and a second channel that can contain compressed gas.

### TECHNICAL FIELD

The embodiments generally relate to mechanical assemblies, and more specifically to a gas spring.

### BACKGROUND

Gas springs are assemblies for pushing open doors, hoods, and trunks. The issue with gas springs, as assemblies, is that at the end of travel, an operator has to use his or her hands for deceleration of the assembly that provides for a smooth stop at full open, which only works vertically, and not horizontally. One way to create a smooth stop at the end of travel is a groove pressed into the tube of said assemblies. The depth of the groove in the tube of said assemblies determines how quickly the shaft extends out from the gas spring. By tapering the groove down to zero at the end of the travel, the shaft is decelerated to a stop, in a vertical direction. When the groove is used horizontally, oil inside the gas spring of the assembly can fill the groove, thereby creating erratic performance. Springs and rubber bump stops have been used but when the assembly hits them with inertia, causing: the material in the assembly to compress and rebound; and the assembly to bounce back and forth, at the end of travel.

### SUMMARY OF THE INVENTION

This summary is provided to introduce a variety of concepts in a simplified form that is further disclosed in the detailed description of the embodiments. This summary is not intended for determining the scope of the claimed subject matter.

In the embodiments provided herein, a gas spring is disclosed. In the gas spring, a pressure tube is operatively connected to a spring network in a decompressed state or a compressed state. A first channel, a second channel; a piston package, a first guiding package, and a second guiding package reside in the pressure tube. The spring network comprises a first spring set and a second spring set. A sealing package is operatively connected to a piston rod in the pressure tube. The piston package comprises a valve, a first stop and second stop, and a piston. The first guiding package is operatively connected to the sealing package and the piston rod. The second guiding package is operatively connected to the piston package and the piston rod.

In some aspects, the gasp spring also includes a first end and a second end.

In some aspects, the first end is a piston rod fitting end and the second end is a pressure cylinder fitting end.

In some aspects, the first channel is operatively connected to the spring network.

In some aspects, the first channel and the second channel are separated by the piston package.

In some aspects, the first spring set comprises a first section proximal or contacting a top section of the pressure tube and a second section proximal or contacting a bottom section of the pressure tube. The first section of the first spring is in a skewed orientation, in relation to the second section of the second spring set in the decompressed state.

In some aspects, the second spring set comprises a first section contacting a top section of the pressure tube and a second section contacting a bottom section of the pressure tube. The first section of the second spring set is in a parallel orientation, in relation to the second section of the second spring set in the decompressed state.

In some aspects, the valve is configured to prevent gas from transporting from a first side to a second side, thereby creating a positive stop.

In some aspects, the valve comprises an orifice. The orifice is configured to be in a closed state of the valve or an opened state of the valve.

In some aspects, the orifice is a drilled hole.

In some aspects, the closed state of the valve leads to a pressure difference between a first surface and a second surface.

In some aspects, the first surface has a different surface area than the second surface. The different surface areas of the first surface and the second surface leads to a force being applied.

In some aspects, the force being applied compresses gas until there is an equalization effect of forces.

In some aspects, the valve also includes an o-ring to contact the orifice in the valve.

In some aspects, the positive stop is configured to receive an additional force.

In some aspects, the orifice is configured to prevent bouncing effects.

In some aspects, the additional force is configured to move the gas spring from a fully extended position.

In some aspects, wherein the fully extended position is a fixed length.

In some aspects, the valve and the network of spring coils create a deceleration for: horizontal applications, vertical applications, and flip over designs.

In some aspects, the network of spring coils is configured to push back when a shaft of the piston rod is compressed.

The embodiments provided herein disclose a gas spring as an assembly, which can work in vertical and horizontal applications, wherein the gas gasket uses a combination of a spring network and valve shut off to create a smooth deceleration at the end of travel and prevent gas from passing from one side to another side.

Unlike currently available gas springs, which are designed and suitable only for vertical applications, the gas spring described herein allows for vertical applications and horizontal applications, while exhibiting smooth deceleration at the end of travel in vertical and horizontal applications, in a cost effective manner with a simple design of the gas spring described herein.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a side view of a gas spring; according to some embodiments;

FIG. 2, FIG. 3, and FIG. 4 illustrate a side view of a gas spring mechanism, according to some embodiments;

FIG. 5 illustrates a top view of the guiding package, according to some embodiments;

FIG. 6 illustrates deceleration of the spring network, according to some embodiments;

FIG. 7 and FIG. 8 illustrate the mechanism for blocking gas flow, according to some embodiments;

FIG. 9 illustrates the spring network in a decompressed state and a compressed state when an O-ring is used, according to some embodiments; and

FIG. 10 illustrates the spring network in a decompressed state and the guiding packet, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a gas spring as an assembly comprising a combination of a spring (i.e., a spring coil network) and a valve shut off (i.e., an orifice in a valve in a piston package in a closed state, as opposed to an opened state) to create a smooth deceleration at the end of travel, in horizontal or vertical applications. By closing the valve near the end of travel, gas is prevented from passing from one side to the other side, thereby creating a smooth stop.

A gas spring is an assembly that includes a pressure tube operatively connected to a spring network. The spring network comprises a first spring set and a second spring set. In the pressure tube, a sealing package is operatively connected to a piston rod. In the pressure tube, a piston package comprises a valve, a first and second stop, and a piston. In the pressure tube, a first guiding package and a second guiding package are in contact with the piston rod. The first guiding package is operatively connected to the sealing package. The second guiding package is operatively connected to the piston package. In the pressure tube, there is a first channel and a second channel that can contain compressed gas.

It is to be understood that the specific measurements used below are provided by way of example and are not intended to limit the scope of the embodiments disclosed herein. The exemplary measurements serve to provide an exemplary embodiment of a gas spring capable of providing the functions described in this disclosure.

In some embodiments, the assembly may be a spring and a plastic stop to construct the gas spring. The spring of the spring network, which has a multitude of shaft and tube diameters, in the pressure tube has a length and a width that are customizable. The pressure tube also has a length, height, and width that are customizable. The assemblies are variably sized, based on the customizable length and width of the spring of the spring network and the customizable length, height, and width of the pressure tube. The spring network can decelerate between 25 millimeters (mm) to 40 mm.

In some embodiments, the piston rod may be composed of hard steel that is often chrome plated or has a black nitride finish, whereby a shaft of the piston rod has a diameter varying 6 mm to 30 mm.

In some embodiments, the sealing package is composed of: (i) a high strength plastic, whereby an orifice therein may or may not utilize a rubber seal to close off the orifice therein; or (ii) powdered metal or the like in high temp applications.

In some embodiments, the guiding package is composed of: (i) a high strength plastic, whereby an orifice therein may or may not utilize a rubber seal to close off the orifice therein; or (ii) powdered metal or the like in high temp applications.

In some embodiments, the orifice in the valve of the piston package is based on the speed or velocity with which the shaft extend, an orifice that is smaller allows the shaft to extend slower than a larger orifice. In some embodiments, the piston head has a diameter, based on the shaft and tube diameter of the assembly.

In some embodiments, the positive stop control has an extended length, wherein the extended length can range from 6 inches to 60 inches.

During use, the gas spring described herein is an assembly that has a spring network and piston package combination suitable for horizontal applications, vertical applications, or at any angle, especially for flip over designs. More particularly, the spring network and piston package include spring and a valve shut off, to create a smooth deceleration at the end of travel in, for example, horizontal applications or vertical applications. By closing the valve near the end of travel, the compressed gas in the channels of the pressure tube is prevented from passing from one side to the other and a smooth stop is created. More particularly, the aforementioned gas spring, which decelerates towards the end of travel, brings the assembly to a smooth stop without any mounting angle limitations. The spring is used to decelerate the assembly and the orifice in a closed state prevents bounce. The force of the spring is reduced significantly, while using the gas pressure to decelerate the shaft of the piston rod. The spring is used only to push back the assembly once the shaft of the piston rod is compressed. More particularly, the combination of the spring and gas pressure working together leads to deceleration and the shaft stopping in a smooth motion. By preventing the gas from passing through the valve, a solid stop (positive) is created which is configured to receive additional force to start moving the assembly from the fully extended position. A solid stop is provided for the end of travel and fixes the extended length of the gas spring, wherein the gas spring can be used in any orientation-specifically designed for horizontal but can be used at any angle especially flip over designs.

Advantages of the gas spring described include: a spring and plastic stop corresponding to a simple and cost effective design; interchangeable of parts, whereby the same parts can be used in multiple different gas springs and the plastic can be injection molded. In contrast to the groove tube, which is different for every gas spring and requires a specific program, die, or tooling for each gas spring and can only be used vertically, the gas spring described herein can be used in any orientation.

FIG. 1 illustrates the gas spring described herein, which is gas spring 100. Gas spring 100 is an assembly containing tube 108 (e.g., a cylindrically shaped pressure tube) that is connected to end 102 (e.g., a pressure cylinder fitting end). Rod 106 (e.g., a piston rod) extends into tube 108 and connects to end 104 (e.g., a piston rod fitting end). Gas spring 100 is preferably in a horizontal position, however gas spring 100 is depicted as rotated 90 degrees in FIG. 1, where the top wall of tube 108 and the bottom wall of tube 108 are denoted.

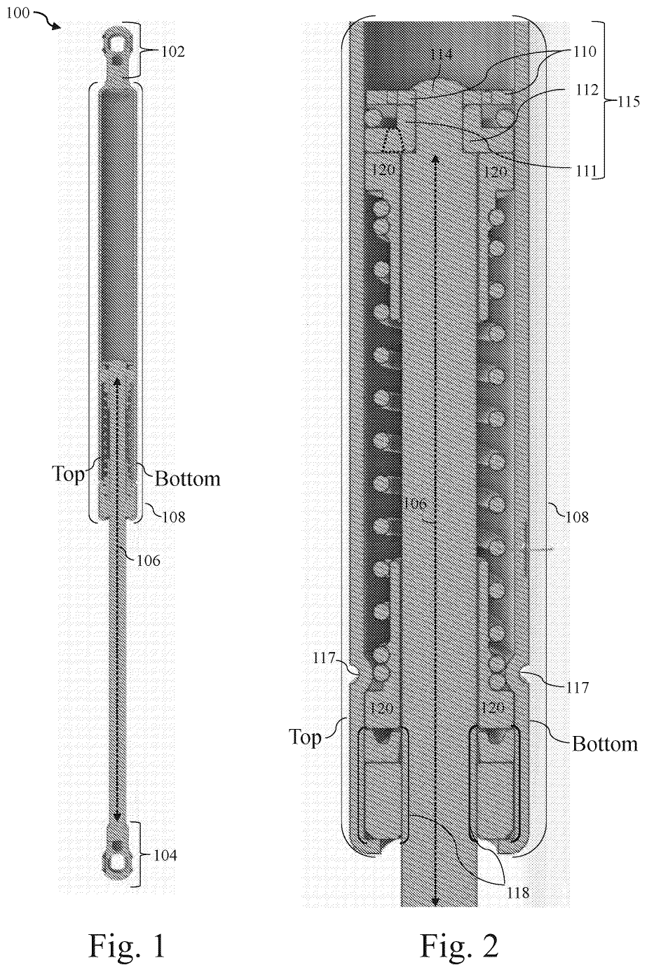

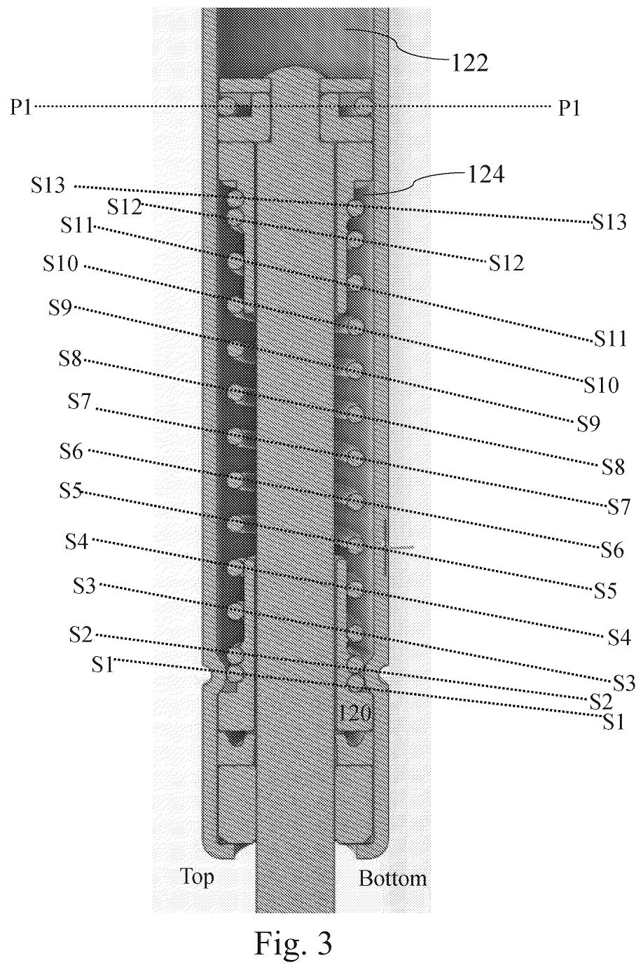

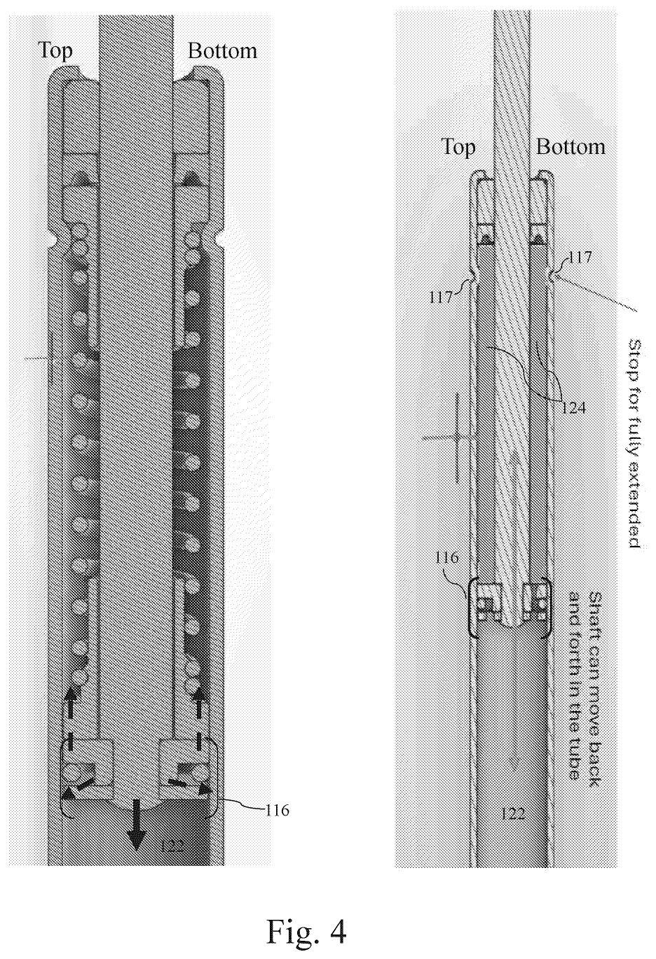

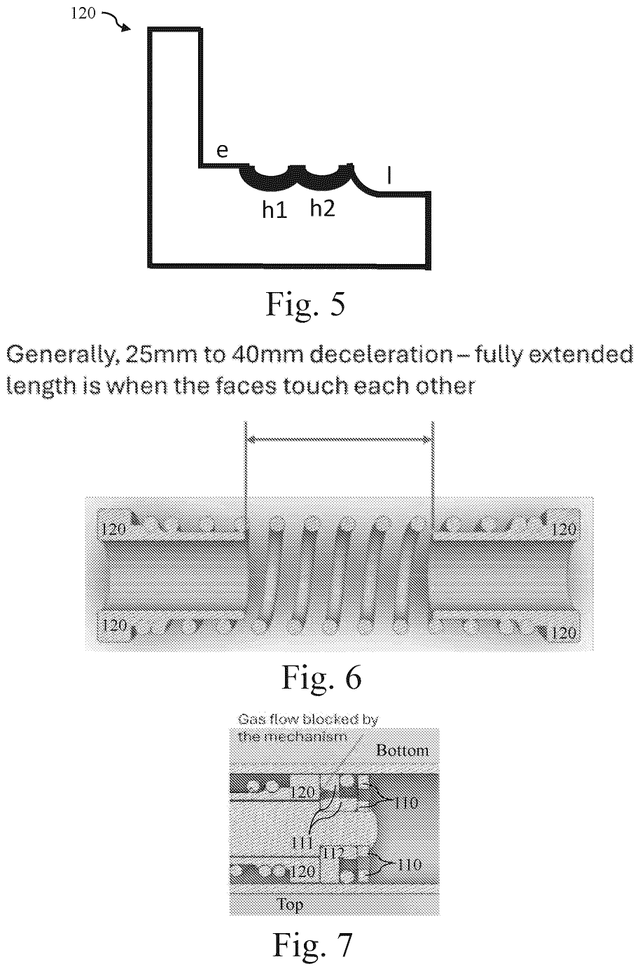

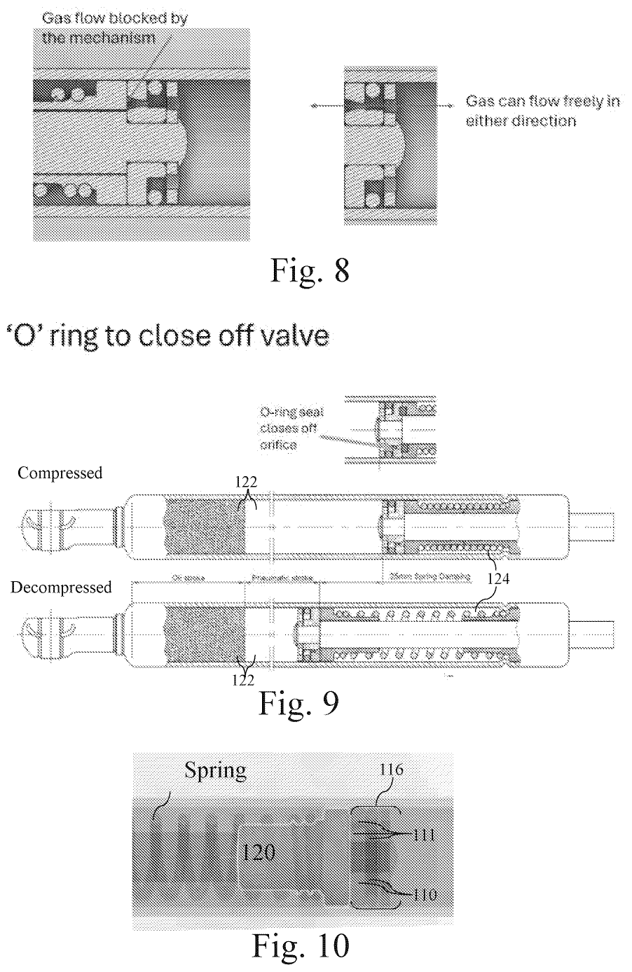

FIG. 2, FIG. 3, FIG. 4, FIG. 5, FIG. 6, FIG. 7, FIG. 8, and FIG. 9 illustrate the mechanism of gas spring 100 and specific components that enable the mechanism of gas spring 100, as cross section pieces. In these cross-sectional views, subunits of a component are depicted and described. Rod 106 is connected to piston package 116, two subunits of scaling package 118, and four subunits of guiding package 120. Two of the four subunits of guiding package 120 are in contact with valve 115; and two of the four subunits of guiding package 120 are in contact with the two subunits of sealing package 118 and two subunits of end stop 117, which each reside on the exterior of tube 108 and curved inwardly towards the spring network. subunit. Each subunit of guiding package 120 is additionally connected to springs of the spring network. Each subunit of scaling package 118 has two bodies each operatively connected to rod 106 and the body distal from the end of tube 108 facing end 104 form a cavity when contacting guiding package 120. Piston package 116 has piston 114 and valve 115, valve 115 has: two subunits of stop 110, one subunit of continuous appendage 112, and one subunit of discontinuous appendage 111 (See FIG. 4).

In FIG. 2, the two subunits of stop 110 are depicted as a continuous rectangle, however a portion of each subunit of stop 110 corresponding to the dotted square box therein is excised out; and continuous appendage 112 and discontinuous appendage 111 are depicted as continuous “L” shaped structures, however a portion of discontinuous appendage 111 corresponding a dotted trapezoid is excised out and there is no portion of continuous appendage 112 excised out. Piston 114 has a base connected to a semi-oval head. The base of piston 114 contacts valve 115 at continuous appendage 112 and discontinuous appendage 111. The semi-oval head contacts a portion of a first subunit of stop 110 and a portion of a second subunit of stop 110. (See FIG. 2.)

Valve 115 is operatively connected to piston 114, wherein valve 115 comprises a drilled hole that is an opened state or a closed state. The only time the drilled hole is in a closed state is when the drilled hole, or orifice, contacts/enables the mechanism for preventing gas from moving from one side to another side. In the closed state of the valve, gas is prevented from moving from one side to another, while also being accompanied by a pressure difference, between a first surface (round flat surface) and a second surface (flat surface with shaft). The first surface and the second surface have different surface areas, leading to a force applied, wherein the force being applied can compress gas until there is an equalization effect of forces. More particularly, with respect to the equalization effect of forces, gas pressure is built on a side for deceleration until the forces are equal on both sides.

The spring network (e.g., S1-S13 and P1 in FIG. 3), pushes the assembly back. S1-13 and P1 reside in channel 122; and channel 122 is separated from channel 124 by piston package 116. A shaft of piston package 116 can move into channel 122 and channel 124, such that the shaft can reach end stop 117 in a fully extended state. (See FIG. 4). A spring can contact or be in close proximity to the wall of tube 108 and guiding packet 120. S1-S13 surround rod 106, wherein each of S1 to S13 has a top section and a bottom section that has a skewed orientation, with respect to each other. P1 surrounds a portion of piston package 116, wherein P1 has a top section and a bottom section that has a parallel orientation, with respect to each other. (See FIG. 4.)

Guiding package 120, which has an elevated step (e), two inverted humps (h1, h2), and a lower step (l), which can each receive a portion of a spring. The springs can move along the elevated step (e), the two inverted humps (h1, h2), and the lower step (l), during compression and decompression. (See FIG. 5.)

Springs, S1-S13, of spring network can contact each of the four subunits of guiding package 120 in a fully extended state, such that the faces thereof touch each other and the length of deceleration in between 25 mm and 40 mm. (See FIG. 6.)

The mechanism for preventing gas from moving from one side to another side is achieved by an orifice in valve structure 115 contacting guiding package 120. More particularly with the mechanism for preventing gas from moving from one side to another side, discontinuous appendage 111 of valve 115 is two disparate subunits separated by a trapezoidal subunit, which is the orifice contacting a subunit of guiding package 120 along the bottom wall of tube 108; and continuous appendage 112 of valve 115 is an “L” shape contacting a subunit of guiding package 120 along the top wall of tube 108. Each subunit of stop 110 of valve 115 has a gap, wherein a subunit of stop 110 along the top wall of tube 108 has a gap that is aligned with continuous appendage 112; and a subunit of stop 110 along the bottom wall of tube 108 has a gap that is aligned with the orifice in discontinuous appendage 111. (See FIG. 7.)

In tube 108, the gas can flow in either direction. The gap in the subunit of stop 110 along the top wall of tube 108 that is aligned with continuous appendage 112 creates a pathway for the gas to reach a portion of the L-shape, thereby not reaching guiding package 120. The gap in the subunit of stop 110 along the bottom wall of tube 108 that is aligned with discontinuous appendage 111 creates a pathway for the gas to reach the orifice of valve structure 115, thereby reaching guiding package 120. (See FIG. 8.)

Additionally, an o-ring can be used to achieve 100% seal of the orifice in valve structure 115. The o-ring sealed off orifice in valve structure 115 can have compressed springs (25 mm) and decompressed springs (40 mm). The oil stroke area in channel 122 in the compressed state is identical to the oil stroke area in channel 122 in the decompressed state. The pneumatic area in channel 122 in the compressed state is larger than the pneumatic area in channel 122 in the decompressed state. (See FIG. 9.)

A three-dimensional rendering of the spring network and a unit of guiding package 120 contacting piston package 117 at valve 115 wherein valve 115 has an orifice, specifically in discontinuous appendage 111. Gas can reach the orifice and therefore reach guiding package 120 via discontinuous appendage 111, while being blocked from reaching guiding package 120 via continuous appendage 112. (See FIG. 10.)

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A gas spring comprising:
a pressure tube operatively connected to a spring network in a decompressed state or a compressed state, wherein the spring network comprises a first spring set and a second spring set;
a sealing package operatively connected to a piston rod in the pressure tube;
a piston package in the pressure tube, wherein the piston package comprises a valve, a first and second stop, and a piston;
a first guiding package in the pressure tube, wherein the first guiding package is operatively connected to the sealing package and the piston rod;
a second guiding package in the pressure tube, wherein the second guiding package is operatively connected to the piston package and the piston rod; and
a first channel and a second channel in the pressure tube.

2. The gas spring of claim 1, further comprising a first end and a second end.

3. The gas spring of claim 3, wherein the first end is a piston rod fitting end and the second end is a pressure cylinder fitting end.

4. The gas spring of claim 1, wherein the first channel is operatively connected to the spring network.

5. The gas spring of claim 1, wherein the first channel and the second channel are separated by the piston package.

6. The gas spring of claim 1, wherein the first spring set comprises a first section proximal or contacting a top section of the pressure tube and a second section proximal or contacting a bottom section of the pressure tube, wherein the first section of the first spring is in a skewed orientation, in relation to the second section of the second spring set in the decompressed state.

7. The gas spring of claim 1, wherein the second spring set comprises a first section contacting a top section of the pressure tube and a second section contacting a bottom section of the pressure tube, wherein the first section of the second spring set is in a parallel orientation, in relation to the second section of the second spring set in the decompressed state.

8. The gas spring of claim 1, wherein the valve is configured to prevent gas from transporting from a first side to a second side, thereby creating a positive stop.

9. The gas spring of claim 1, wherein the valve comprises an orifice, wherein the orifice is configured to be in a closed state of the valve or an opened state of the valve.

10. The gas spring of claim 9, wherein the orifice is a drilled hole.

11. The gas spring of claim 9, wherein the closed state of the valve leads to a pressure difference between a first surface and a second surface.

12. The gas spring of claim 11, wherein the first surface has a different surface area than the second surface, thereby leading to a force being applied.

13. The gas spring of claim 12, wherein the force being applied compresses gas until there is an equalization effect of forces.

14. The gas spring of claim 9, wherein the valve further comprises an o-ring to contact the orifice in the valve.

15. The gas spring of claim 8, wherein the positive stop is configured to receive an additional force.

16. The gas spring of claim 9, wherein the orifice is configured to prevent bouncing effects.

17. The gas spring of claim 15, wherein the additional force is configured to move the gas spring from a fully extended position.

18. The gas spring of claim 17, wherein the fully extended position is a fixed length.

19. The gas spring of claim 1, wherein the valve and the network of spring coils create a deceleration for: horizontal applications, vertical applications, and flip over designs.

20. The gas spring of claim 1, wherein the network of spring coils is configured to push back when a shaft of the piston rod is compressed.
